(19) United States
(12) Patent Application Publication
(10) Pub. No.: US 2003/0093344 A1
(43) Pub. Date: May 15, 2003

(54) Compensation for electronic document retrieval and production

(76) Inventor: Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/037,744

(22) Filed: Nov. 9, 2001

(51) Int. Cl. G06F 17/60

(52) U.S. Cl. 705/35

(57) ABSTRACT

A method and system for compensating a recipient for obtaining and printing an electronic document. Electronic data, or print content, representing the document is produced. A compensation value is calculated. The print content is downloaded to a selected printing system and printed. The recipient is provided compensation according to the compensation value. The compensation may take the form of a check or a coupon to be printed with the advertisement. It may take the form of payment to particular account such as a checking or savings account managed by a bank, a credit card account, a consumer account managed by a retailer or manufacturer of the goods or services being advertised.

### FIELD OF THE INVENTION

The present invention relates generally to document production, and more particularly to a system and method for compensating a recipient of an electronic document for retrieving and/or printing the document.

### BACKGROUND OF THE INVENTION

The volume of unsolicited printed advertisements, commonly referred to as “junk-mail” passing through our mail system is ever increasing. The automation used to produce these advertisements typically renders the printed material easy to recognize. For example, the material may be addressed to “current resident” or “homeowner,” or, perhaps bulk rate postage may be used. The effort required to sort through each day's mail often causes recipients to immediately discard the unsolicited advertisements. Moreover, mass mailing of solicited or unsolicited advertisements requires an advertiser to either develop an expensive infrastructure to print, sort, and mail the advertisements or to pay a third party to do the same.

With the increasing power and popularity of the Internet, efforts have been directed to delivering advertisements using electronic mail. This significantly reduces the physical infrastructure required to produce and deliver the advertisements. However, for the same reasons recipients discard the printed advertisement, recipients of unsolicited electronic mail often delete the mail without even reading it. Filtering applications have been developed that, when effective, prevent unsolicited mail from reaching its intended target.

What is needed is a method and system for increasing the probability that a recipient of an unsolicited advertisement will in fact read the advertisement. The system and method would compensate the recipient for retrieving and/or printing the advertisement.

### SUMMARY OF THE INVENTION

The present invention is directed to a method and system for compensating a recipient for obtaining and printing an electronic document. Electronic data, or print content, representing the document is produced. A compensation value is calculated. The print content is downloaded to a selected printing system and printed. The recipient is provided compensation according to the compensation value. The compensation may take the form of a check or a coupon to be printed with the advertisement. It may take the form of payment to particular account such as a checking or savings account managed by a bank, a credit card account, a consumer account managed by a retailer or manufacturer of the goods or services being advertised.

### DESCRIPTION OF THE DRAWINGS

FIG. 1 illustrates compensation content in the form of a negotiable instrument and an advertisement printed on a single sheet.

FIG. 2 illustrates compensation content in the form of a coupon and an advertisement printed on a single sheet.

FIG. 3 is a schematic representation of a computing environment according to one embodiment of the present invention.

FIG. 4 is a block diagram illustrating an embodiment of the present invention in which a server delivers and a client retrieves print content using electronic mail.

FIG. 5 is a flow diagram illustrating the steps taken to provide compensation for producing print content according to one embodiment of the present invention.

FIG. 6 is a block diagram illustrating an embodiment of the present invention in which a client automatically retrieves print content from a server.

FIG. 7 is a block diagram illustrating an embodiment in which a server delivers print content directly to a printer.

### DETAILED DESCRIPTION OF THE INVENTION

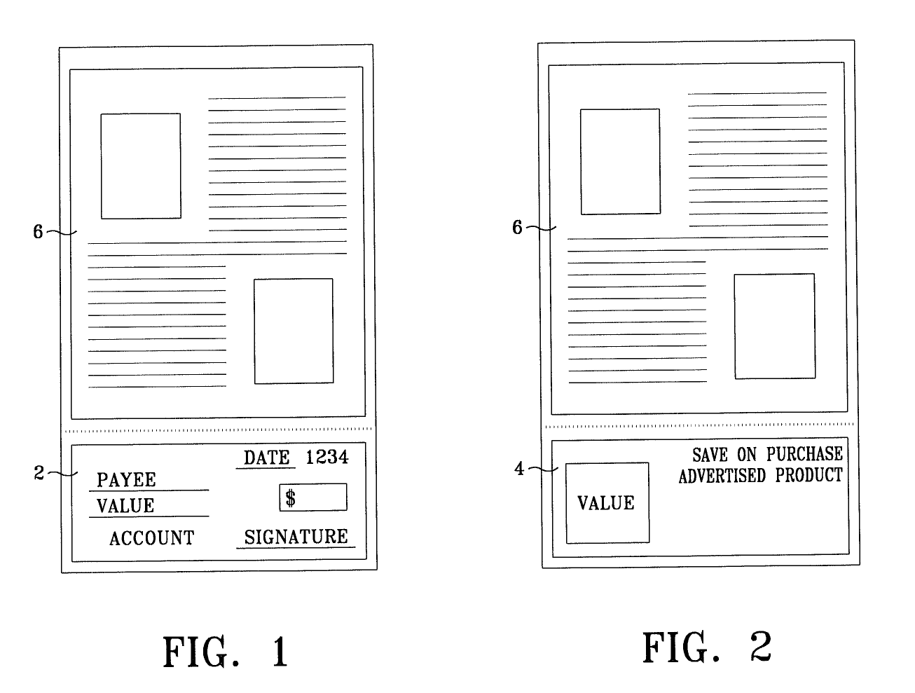

Introduction: The concept underlying the present invention is to provide a person compensation for obtaining and printing an advertisement for the sale of goods and/or services. It is expected that the advertisements will be delivered electronically over the Internet as an electronic mail, an electronic mail attachment, as web content, or any other form of electronic data capable of being transmitted across a computer network. These advertisements could also be provided via a diskette, CD ROM or DVD that contains the advertisements or links to additional advertisement content on the Internet when accessed. The compensation can take a number of forms such as a check or other negotiable instrument, a coupon for a particular item(s) or service(s), or a coupon providing a credit for any items or services purchased at a particular store. Referring to FIGS. 1 and 2, the checks 2 and coupons 4 can be included in the electronic data providing the advertisement 6 such that a check 2 or coupon 4 is printed with the advertisement 6. Compensation may also take the form of payment to a specified account such as a checking, savings, or credit or consumer account managed by the advertiser or a third party financial service.

It is expected that the various embodiments of the present invention will increase the likelihood that the recipient of an advertisement will in fact read the advertisement. Advertisers will avoid postage costs and mailing delays. The recipients will be compensated for and encouraged to print only those advertisements in which they are actually interested. The compensation will alleviate the customer's concerns about wasting consumables such as ink or toner and paper as well as wear and tear on the printer itself. Large and expensive infrastructures associated with printing, sorting, and mailing advertisements will be eliminated. To lower costs further the advertiser need only stop providing the print content or target recipients more selectively based upon known purchasing habits.

In the following description, the term “print content” will be used to describe the electronic data to be printed. It is expected that the print content will be a digital representation of an advertisement, but may instead represent any other type of document such as a novel, essay, poem, or graphic. In some cases the “print content” might also represent an audio file or movie that runs on the recipient's PC, before or while the compensation content is printed or transferred to the customer. The term “compensation content” will be used to describe the electronic data representing compensation or payment for obtaining and/or producing the print content. As described above, compensation content may be electronic data representing a negotiable instrument or a coupon. Compensation content may also be electronic data representing instructions for a financial service to provide payment to a specified account. The financial service may be a bank managing a checking, savings, or credit account or it may be a retailer or manufacturer managing a consumer account.

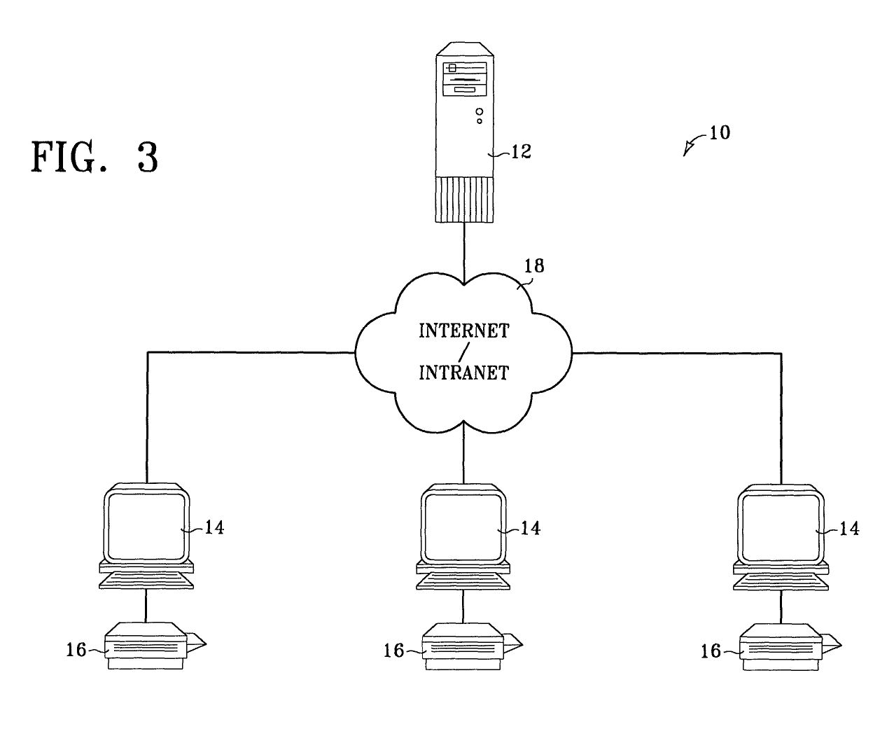

FIG. 3 illustrates schematically a computing environment 10 for providing compensation for document production. Although the various embodiments of the invention disclosed herein will be described with reference to environment 10, the invention is not limited to use with environment 10. The invention may be implemented in or used within any environment in which it is desirable to compensate an individual for obtaining and/or printing an electronic document. The following description and the drawings illustrate only a few exemplary embodiments of the invention. Other embodiments, forms, and details may be made without departing from the spirit and scope of the invention, which is expressed in the claims that follow this description.

Referring to FIG. 3, environment 10 includes server 12, clients 14, printers 16, and link 18. Server 12 represents generally any combination of hardware and programming capable of providing electronic data over link 18. Clients 14, typically personal computers, represent generally any combination of hardware and programming capable for obtaining electronic data from server 12 over link 18. Printers 16 represent generally any image forming device capable of receiving instructions to print electronic data—that is—to produce the electronic data in a physical form. Typically this means printing the data on one or more media sheets such as paper. However, printers 16 need only be able to produce the electronic data in some tangible format. In the description that follows, each client 14 and printer 16 pair will in some instance be referred to as a printing system. Printer 16 alone may be referred to as a printing system where it incorporates some or all of the functions of client 14.

Link 18 interconnects server 12 with clients 14 and printers 16. Link 18 represents generally a cable, wireless, or remote connection via a telecommunication link, an infrared link, a radio frequency link, or any other connector or system that provides electronic communication between server 12, clients 14, and printers 16. Link 18 may represent an intranet, the Internet, or a combination of both. The path followed by link 18 between devices 12, 14, and 16 in the schematic view of FIG. 3 represents the logical communication path between these devices, not necessarily the physical path between the devices. Devices 12, 14, and 16 can be connected to the network at any point and the appropriate communication path established logically between the devices.

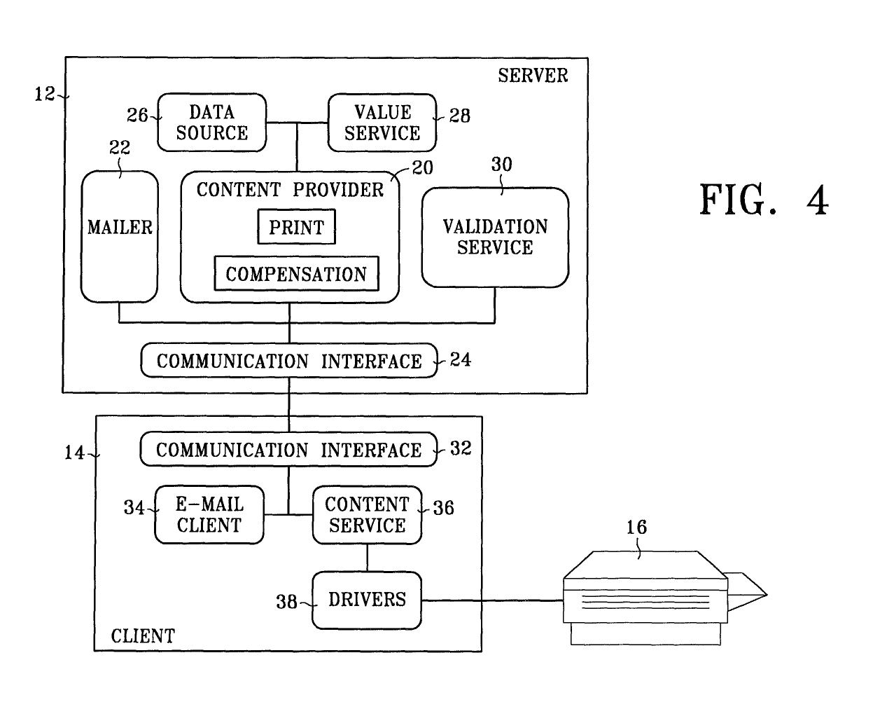

First Embodiment: FIG. 4 illustrates an embodiment of the present invention in which print content is delivered from server 12 to client 14 utilizing electronic mail. As shown server 12 includes content provider 20, mailer 22, and communication interface 24. Content provider 20 represents generally any programming capable of serving print and compensation content. Mailer 22 represents any programming capable of generating and/or assembling and then sending data in the form of electronic mail. Communication interface 24 represents any combination of programming and/or hardware enabling server 12 to communicate with client 14 and/or printer 16 over link 18.

Server 12 also includes data source 26, value service 28, and validation service 30. Data source 26 represents generally any memory location accessible by content provider 20 and/or mailer 22. Data source may be a hard drive, removable media, flash memory, ROM, RAM, or any other structure or device capable of retrievably storing electronic data. Value service 28 represents generally any programming capable of calculating a compensation value. The term compensation values as used herein represents a monetary value. Validation service 30 represents any programming capable of validating compensation content. It is expected that advertisers and other providers of print content will not wish to pay a recipient of an advertisement unless part or all of the print content has actually been printed. Validation service 30 then is programming capable of obtaining confirmation that the print content has been printed and then validating the compensation content. Where payment is to be made to an account, validating includes releasing compensation content instructing that payment be made to the account. Where compensation is in the form of a coupon or check, validation is more difficult because once printed it can be used. This is especially true in the case of a check. Validation then may involve identifying when print content has not been printed in its entirety or as desired and preventing compensation content from being sent to the same recipient in the future.

Still referring to FIG. 4, the printing system includes client 14 and printer 16. Client 14 includes communication interface 32, mail client 34, content service 36, and drivers 38. Communication interface 32 represents any combination of hardware and/or programming enabling client 14 to communicate with server 12 over link 18. Mail client 34 is generally any programming capable of retrieving electronic mail and providing a user-interface enabling a recipient of the electronic mail to view and otherwise access or manipulate the mail's contents. Content service 36 represents any programming capable of obtaining electronic data—specifically print and compensation content—from mail client 34 or directly from server 12 and instructing printer 16 to print the data. It is expected that content service 36 will also include programming capable of communicating with and informing validation service 30 whether print content has been successfully produced. For example, content service 36 may be a web browser, word processor, or image editing application.

Drivers 38 represent programming capable of controlling printer 16. Drivers 38 act like a translator between the printer 16 and content service 36 taking generic printing commands issued by content service 36 and converting them into specialized commands recognizable by printer 16.

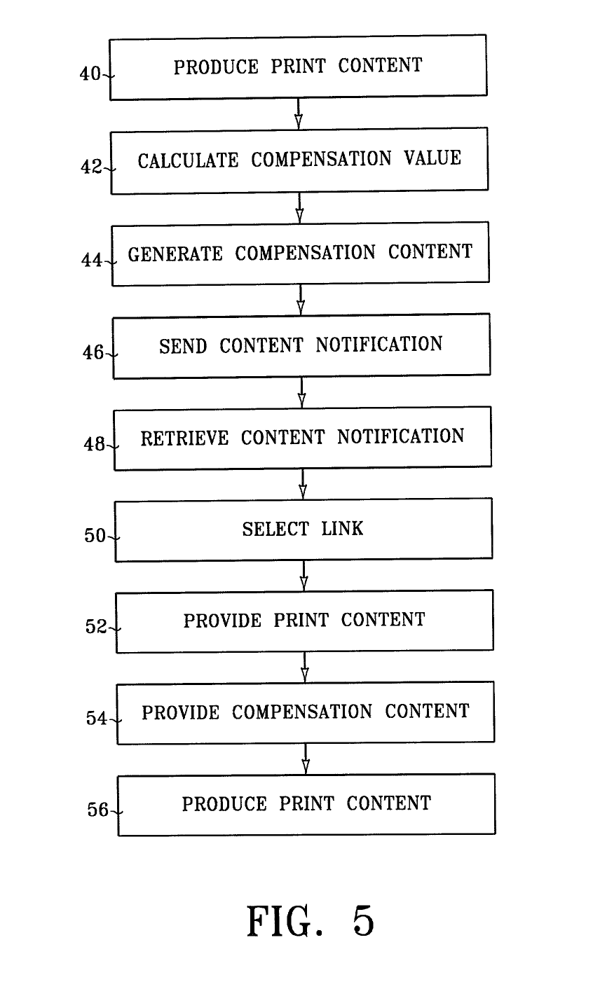

The operation of the embodiment illustrated in FIG. 4 will now be discussed with reference to the flow diagram of FIG. 5. Print content is first produced (step 40). This may involve the use of a word processor, graphics design program, hypertext-editor, and/or any other application capable of generating electronic data suitable for use as print content. The print content is typically stored in data source 26, but may be stored in any memory location accessible by server 12. Value service 28 then examines the print content and calculates a compensation value (step 42). The compensation value may be based upon the number of sheets required to produce the print content on printer 16, or on a more complex formula. Using the calculated value, value service 28 generates compensation content (step 44).

Mailer 22 generates and sends a content notification to a specified address (step 46). A content notification is at a minimum an electronic mail containing an URL (Uniform Resource Locator), IP (internet Protocol) address, or other information identifying and enabling access to the print content over link 18. The notification may also contain information identifying the sender of the print content, a description of the print and compensation content, and any other useful information. Alternatively, mailer 22 may generate and deliver an electronic mail containing print content as an attachment or as the body of the electronic mail itself.

Mail client 34 then retrieves the content notification (step 48). For example, where the content notification contains an URL, commonly referred to as a “link”, mail client 34 generates a user-interface (typically shown on a monitor) displaying the link. The recipient of the mail responds to the notification by selecting the link (step 50). Mail client 34 then opens content service 36, in this case a web browser. Content service 36, using the selected link, requests and content provider 20 provides the print and compensation content (steps 52 and 54 respectively). Using drivers 38, content service 36 instructs printer to produce the print content (step 56).

Where compensation content is a check or a coupon, content provider 20, upon request from content service 36, may generate or assemble a single electronic document containing both the print and compensation content and transmit the electronic document to content service 36 to be printed in step 56. Where compensation content is electronic data instructing payment to a particular account, step 54 may not be completed until compensation service 36 informs validation service 30 that the print content has been produced on printer 16.

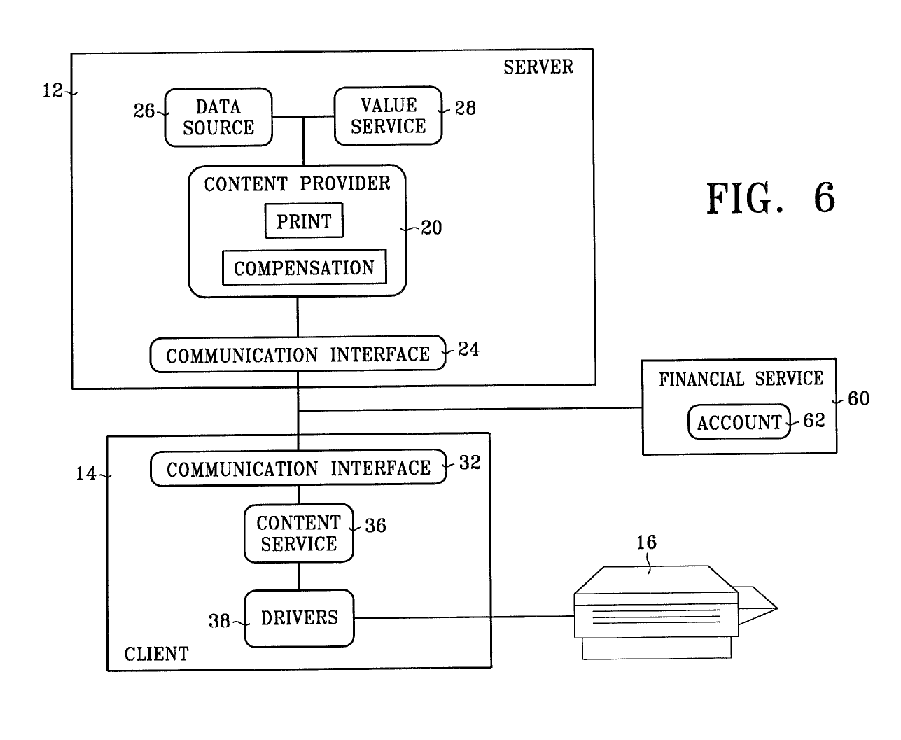

Second Embodiment: FIG. 6 illustrates an embodiment of the present invention in which client 14, without user intervention, initiates retrieval of print content from server 12 and produces the content on printer 16. Server 12 includes content provider 20, communication interface 24, data source 26, and value service 28. Client 14 includes communication interface 32, content service 36, and drivers 38.

In this embodiment, content service 36 includes programming capable of communicating with content provider 20, without user intervention, to obtain print content. This may be accomplished in a number of ways. As new print content is generated or detected in data source 26, value service 28 examines the print content, calculates a compensation value, and generates compensation content accordingly. Content provider 20 then delivers that print content directly to content service 36. Alternatively, content service 36 may be capable of periodically communicating with content provider 20 requesting new print content.

Upon receipt of the print content, content service 36, using drivers 38, instructs printer 16 to produce the print content. Where compensation content is a check or a coupon, content provider 20 provides the compensation content to be produced along with the print content. Where compensation content includes instructions to pay a particular account, content provider 20 delivers the compensation content to the appropriate financial service 60 managing the specified account 62.

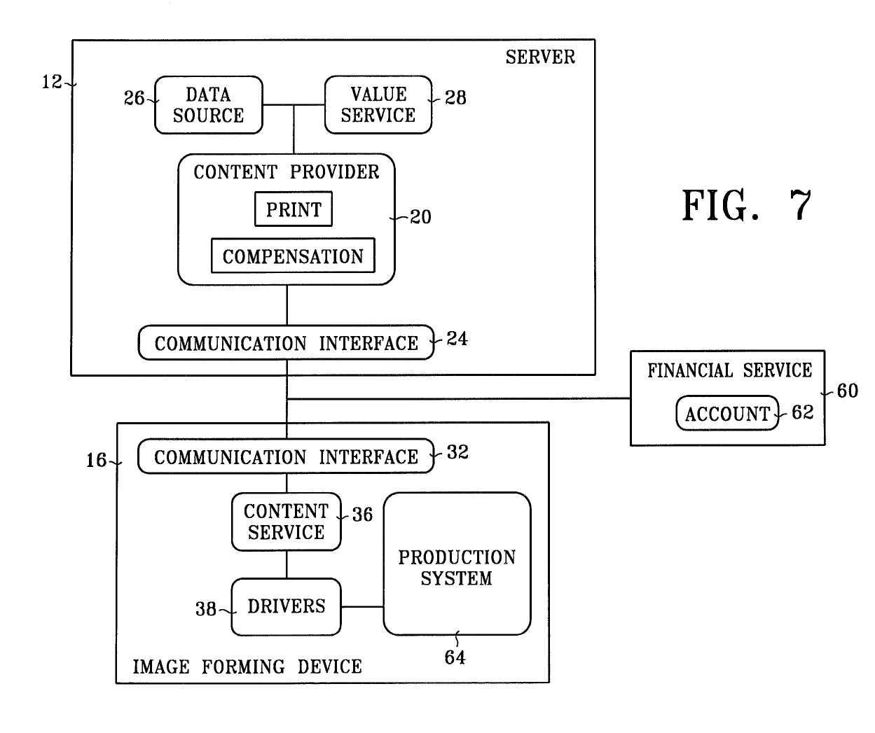

Third Embodiment: FIG. 7 illustrates an embodiment of the present invention in which server 12 delivers print content directly to printer 16. Again, server 12 includes content provider 20, communication interface 24, data source 26, and value service 28. Communication interface 32, content service 36, and drivers 38 are now located on printer 16 eliminating the need for client 14. Printer 16 also includes production system 64 which represents generally any combination of hardware and supporting programming capable of producing print content on one or more media sheets.

In this embodiment, content service 36 is capable of communicating with content provider 20, without user intervention, to retrieve print content. This may be accomplished in a number of ways. As new print content is generated or detected in data source 26, value service 28 examines the print content, calculates a compensation value, and generates compensation content accordingly. Content provider 20 then delivers that print content directly to content service 36 on printer 16. Alternatively, content service 36 may be capable of periodically communicating with content provider 20 requesting new print content.

Upon receipt of the print content, content service 36, using drivers 38, instructs production system 64 to produce the print content. Where compensation content is a check or a coupon, content provider 20 provides the compensation content to be produced along with the print content. Where compensation content is instruction to pay a particular account, compensation provider delivers the compensation content to the appropriate financial service 60 managing the specified account 62.

The diagrams of FIGS. 1-4 and 6-7 show the architecture, functionality, and operation of one implementation of the present invention. If embodied in software or other programming, each block may represent a module, segment, or portion of code that comprises one or more executable instructions to implement the specified logical function(s). If embodied in hardware, each block may represent a circuit or a number of interconnected circuits to implement the specified logical function(s). Although the flow chart of FIG. 5 shows a specific order of execution, the order of execution may differ from that which is depicted. For example, the order of execution of two or more blocks may be scrambled relative to the order shown. Also, two or more blocks shown in succession in FIG. 5 may be executed concurrently or with partial concurrence. All such variations are within the scope of the present invention.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A method for providing compensation for document production, comprising:
providing print content; and
providing compensation content for use of a device to obtain and/or produce the print content.

2. The method of claim 1, wherein the act of providing print content comprises providing electronic data representing an advertisement to be printed.

3. The method of claim 1, wherein the act of providing compensation content comprises providing electronic data representing a negotiable instrument to be printed.

4. The method of claim 1, wherein the act of providing compensation content comprises providing electronic data representing a coupon to be printed.

5. The method of claim 1, wherein the act of providing compensation content comprises providing electronic data instructing payment to a specified account.

6. The method of claim 1, further comprising calculating a compensation value, and wherein the act of providing compensation content comprises providing compensation content according to the compensation value.

7. The method of claim 6, wherein the act of calculating a compensation value comprises calculating a compensation value based upon the number of sheets required to produce the print content.

8. The method of claim 6, wherein the act of calculating comprises calculating the compensation value based upon the number of sheets actually used to produce the print content.

9. The method of claim 1, further comprising verifying that at least a portion of the print content has been produced and wherein the act of providing compensation content comprises providing the compensation content only upon verification.

10. The method of claim 1, further comprising sending a print content notification, and wherein the act of providing print content comprises providing the print content after receiving a response to the notification.

11. The method of claim 10, wherein the act of sending the print content notification comprises sending electronic mail including a link to the print content, and wherein the act of providing the print content comprises providing the print content after the electronic mail has been opened and the link has been selected.

12. The method of claim 1, wherein the act of providing print content comprises downloading the print content to a selected printing system and producing the print content without user intervention.

13. A method for providing compensation for document production, comprising:
producing electronic data representing an advertisement;
calculating a compensation value for use of a device to obtain and/or print the electronic data;
downloading the electronic data to a selected printing system and producing the advertisement without user intervention; and
providing a recipient compensation according to the compensation value.

14. A method for providing compensation for document production, comprising:
producing electronic data representing an advertisement;
calculating a compensation value for use of a device to obtain and/or print the electronic data;
sending an electronic mail containing a link to the electronic data, the electronic mail being addressed to a specified recipient;
downloading the electronic data to a selected printing system once the recipient has opened the electronic mail and selected the link; and
providing a recipient compensation according to the compensation value.

15. A computer program product for providing compensation for document production, the product comprising a computer useable medium having machine readable instructions thereon for:
providing print content; and
providing compensation content for use of a device to obtain and/or produce the print content.

16. The product of claim 15, wherein the instructions for providing print content include instructions for providing electronic data representing an advertisement to be printed.

17. The product of claim 15, wherein the instructions for providing compensation content include instructions for providing electronic data representing a negotiable instrument to be printed.

18. The product of claim 15, wherein the instructions for providing compensation content include instructions for providing electronic data representing a coupon to be printed.

19. The product of claim 15, wherein the instructions for providing compensation content include instructions for providing electronic data instructing monetary transfer to a specified account.

20. The product of claim 15, further comprising instructions for calculating a compensation value, and wherein the instructions for providing compensation content include instructions for providing compensation content according to the compensation value.

21. The product of claim 20, wherein the instructions for calculating a compensation value include instructions for calculating a compensation value based upon the number of sheets required to produce the print content.

22. The product of claim 20, wherein the instructions for calculating include instructions for calculating the compensation value based upon the number of sheets actually used to produce the print content.

23. The product of claim 15, further comprising instructions for verifying that at least a portion of the print content has been produced and wherein the instructions for providing compensation content include instructions for providing compensation content only upon verification.

24. The product of claim 15, further comprising instructions for sending a print content notification, and wherein the instructions for providing print content include instructions for providing the print content after receiving a response to the notification.

25. The product of claim 24, wherein the instructions for sending the print content notification include instructions for sending electronic mail including a link to the print content, and wherein the instructions for providing the print content include instructions for providing the print content after the electronic mail has been opened and the link has been selected.

26. The product of claim 15, wherein the instructions for providing print content include instructions for downloading the print content to a selected printing system and producing the print content without user intervention.

27. A computer program product for providing compensation for document production, the product comprising a computer useable medium having machine readable instructions thereon for:
producing electronic data representing an advertisement;
calculating a compensation value for use of a device to obtain and/or print the electronic data;
downloading the electronic data to a selected printing system and producing the advertisement without user intervention; and
providing a recipient compensation according to the compensation value.

28. A computer program product for providing compensation for document production, the product comprising a computer useable medium having machine readable instructions thereon for:
producing electronic data representing an advertisement;
calculating a compensation value for use of a device to obtain and/or print the electronic data;
sending an electronic mail containing a link to the electronic data, the electronic mail being addressed to a specified recipient;
downloading the electronic data to a selected printing system once the recipient has opened the electronic mail and selected the link; and
providing a recipient compensation according to the compensation value.

29. A system for providing compensation for document production, the system comprising:
a content provider operable to serve print and compensation content; and
a content service operable to obtain the print and compensation content from the content provider.

30. The system of claim 29, wherein the content service is further operable to obtain the compensation content.

31. The system of claim 29, further comprising an image forming device in electronic communication with the content service, the content service being further operable to instruct the image forming device to produce the obtained content.

32. The system of claim 29, wherein the compensation content includes electronic data representing a negotiable instrument.

33. The system of claim 29, wherein the compensation content includes electronic data representing a coupon.

34. The system of claim 29, wherein the compensation content includes information identifying an account and a compensation value and the content provider is further operable to instruct payment to the account according to the compensation value.

35. The system of claim 29, further comprising a value service operable to calculate a compensation value and generate the compensation content using the compensation value.

36. The system of claim 35, wherein the value service is operable to calculate the compensation value according to a number of sheets required to produce the print content.

37. The system of claim 29, further comprising:
a mailer operable to generate and send electronic mail containing a link to the print content; and
an electronic mail client operable to obtain the electronic mail and provide an interface enabling a recipient to select the link.

38. The system of claim 29 wherein the content service is operable to obtain the print content without user intervention.

39. The system of claim 38, further comprising an image forming device, and wherein the content service is further operable to, without user intervention, obtain the print content and instruct the image forming device to produce the print content.

40. The system of claim 29, wherein the content service includes a web browser.

41. The system of claim 29 further comprising an image forming device containing the content service, and wherein the content provider is further operable to transmit the print content to the content service, and the content service is further operable to instruct the image forming device to produce the print content.

42. The system of claim 29, wherein the content service is further operable to confirm that the print content has been produced on an image forming device, the system further comprising a validation service operable to receive confirmation from the content service and to validate the compensation content only upon receipt of the confirmation.
